(19) United States
(12) Patent Application Publication
(10) Pub. No.: US 2017/0287167 A1
(43) Pub. Date: Oct. 5, 2017

(54) CAMERA AND CAMERA CALIBRATION METHOD

(71) Applicant: KOREA ADVANCED INSTITUTE OF SCIENCE AND TECHNOLOGY, Daejeon (KR)

(72) Inventors: In So KWEON, Daejeon (KR); Hyowon HA, Daejeon (KR); Yunsu BOK, Daejeon (KR); Kyungdon JOO, Daejeon (KR); Jiyoung JUNG, Daejeon (KR)

(21) Appl. No.: 15/474,940

(22) Filed: Mar. 30, 2017

(30) Foreign Application Priority Data
Mar. 30, 2016 (KR) 10-2016-0038473

(51) Int. Cl. G06T 7/80; H04N 17/00

(52) U.S. Cl. CPC G06T 7/80; H04N 17/002

(57) ABSTRACT

Disclosed is a camera calibration method of a calibration apparatus, including: receiving plural pattern image information photographed by a camera; setting points where edges of patterns of the plural pattern image information overlap with each other as a plurality of primary features; and calibrating the camera by using the plurality of primary features, in which the plural pattern image information includes first vertical pattern image information, second vertical pattern image information complementary to the first vertical pattern image information, first horizontal pattern image information, and second horizontal pattern image information complementary to the first horizontal pattern image information.

### CROSS-REFERENCE TO RELATED APPLICATION

This application claims priority to and the benefit of Korean Patent Application No. 10-2016-0038473 filed in the Korean Intellectual Property Office on Mar. 30, 2016, the entire contents of which are incorporated herein by reference.

### BACKGROUND

### (a) Field

The present invention relates to a camera and a camera calibration method.

### (b) Description of the Related Art

Korean Patent Unexamined Publication No. 10-2015-0089678 (Aug. 5, 2015) (hereinafter, referred to as Prior Document 1) discloses a calibration method for a stereo camera system.

Referring to paragraph [0005] of Prior Document 1, a general calibration method may be performed after a distance between a checker board and a camera is adjusted to an actual use distance of the camera. That is, a pattern size of the checker board and the distance between the checker board and the camera are determined depending on a predetermined focus distance of the camera. Further, during a calibration process, since the checker board needs to be photographed at various angles several times, there is also inconvenience that the checker board or the camera needs to be moved according to the focus distance of the camera.

Therefore, for easier camera calibration, a camera calibration method is required, which may be performed even when the camera is out of accurate focus.

Prior Document 1 presents a method that can easily perform calibration in real time while a vehicle moves, but referring to paragraphs [0075] and [0090] of Prior Document 1, in Prior Document 1, the camera is calibrated by measuring a relative distance change among a plurality of cameras and an angular rotation change amount while the vehicle is driven.

That is, Prior Document 1 discloses a method for calibrating the camera by updating extrinsic parameters of the camera in real time, but does not consider a method for acquiring intrinsic parameters and accurate features of the camera.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a camera and a camera calibration method which are capable of performing calibration even when a camera is out of accurate focus.

An exemplary embodiment of the present invention provides a camera calibration method of a calibration apparatus, including: receiving plural pattern image information photographed by a camera; setting points where edges of patterns of the plural pattern image information overlap with each other as a plurality of primary features; and calibrating the camera by using the plurality of primary features, in which the plural pattern image information includes first vertical pattern image information, second vertical pattern image information complementary to the first vertical pattern image information, first horizontal pattern image information, and second horizontal pattern image information complementary to the first horizontal pattern image information.

The plural pattern image information may further include monochromatic pattern image information and the camera calibration method may further include removing the monochromatic pattern image information from the first vertical pattern image information, the second vertical pattern image information, the first horizontal pattern image information, and the second horizontal pattern image information.

The camera calibration method may further include generating plural pattern correction image information including first vertical pattern correction image information, second vertical pattern correction image information, first horizontal pattern correction image information, and second horizontal pattern correction image information by Gaussian-blurring the first vertical pattern image information, the second vertical pattern image information, the first horizontal pattern image information, and the second horizontal pattern image information.

The setting of the points as the plurality of primary features may include generating vertical skeleton information by using the points where the edges of the patterns of the first vertical pattern correction image information and the second vertical pattern correction image information overlap with each other, generating vertical skeleton information by using the points where the edges of the patterns of the first horizontal pattern correction image information and the second horizontal pattern correction image information overlap with each other, and setting points where the vertical skeleton information and the horizontal skeleton information overlap with each other as the plurality of primary features.

The calibrating of the camera by using the plurality of primary features may include acquiring a plurality of first vertical pattern brightness profiles and a plurality of second vertical pattern brightness profiles in a plurality of vertical pattern gradient directions based on the plurality of primary features in each of the first vertical pattern correction image information and the second vertical pattern correction image information, acquiring a plurality of first horizontal pattern brightness profiles and a plurality of second horizontal pattern brightness profiles in a plurality of horizontal pattern gradient directions based on the plurality of primary features in each of the first horizontal pattern correction image information and the second horizontal pattern correction image information, acquiring a plurality of secondary features corresponding to the plurality of primary features by using the plurality of first vertical pattern brightness profiles, the plurality of second vertical pattern brightness profiles, the plurality of first horizontal pattern brightness profiles, and the plurality of second horizontal pattern brightness profiles, and calibrating the camera by using the plurality of secondary features.

The acquiring of the plurality of secondary features corresponding to the plurality of primary features may include acquiring a standard deviation of a plurality of anticipated Gaussian blur kernels corresponding to the plurality of secondary features.

The acquiring of the plurality of secondary features corresponding to the plurality of primary features may include acquiring a plurality of vertical pattern single profiles by summing up the plurality of first vertical pattern brightness profiles and the plurality of second vertical pattern brightness profiles corresponding thereto, acquiring a plurality of first vertical pattern anticipated brightness profiles and a plurality of second vertical pattern anticipated brightness profiles by separating the plurality of vertical pattern single profiles so that the brightness profiles minimally overlap with each other based on the plurality of primary features, acquiring a plurality of horizontal pattern single profiles by summing up the plurality of first horizontal pattern brightness profiles and the plurality of second horizontal pattern brightness profiles corresponding thereto, acquiring a plurality of first horizontal pattern anticipated brightness profiles and a plurality of second horizontal pattern anticipated brightness profiles by separating the plurality of horizontal pattern single profiles so that the brightness profiles minimally overlap with each other based on the plurality of primary features, and acquiring the plurality of secondary features which allows values acquired by convoluting a plurality of anticipated Gaussian blur kernels with the plurality of first vertical pattern anticipated brightness profiles, the plurality of second vertical pattern anticipated brightness profiles, the plurality of first horizontal pattern anticipated brightness profiles, and the plurality of second horizontal pattern anticipated brightness profiles to have minimum differences from the plurality of first vertical pattern brightness profiles, the plurality of second vertical pattern brightness profiles, the plurality of first horizontal pattern brightness profiles, and the plurality of second horizontal pattern brightness profiles, with respect to the plurality of respective primary features.

The calibrating of the camera by using the plurality of secondary features may include calculating a refraction correction vector to which a refractive index of a front panel of a display apparatus is reflected, and acquiring parameters of the camera by using the refraction correction vector and the plurality of secondary features.

The acquiring of the parameters of the camera may further include acquiring the thickness of the front panel.

The first vertical pattern image information may be the vertical stripe pattern in which the first and second colors are alternated and the second vertical pattern image information may be the vertical stripe pattern in which the second and first colors are alternated, which is complimentary to the first vertical pattern image information, and the first horizontal pattern image information may be the horizontal stripe pattern in which the first and second colors are alternated and the second horizontal pattern image information may be the horizontal stripe pattern in which the second and first colors are alternated, which is complimentary to the first horizontal pattern image information.

According to exemplary embodiments of the present invention, a camera and a camera calibration method are capable of performing calibration even when a camera is out of accurate focus.

### BRIEF DESCRIPTION OF THE DRAWINGS

FIG. 1 is a diagram for describing camera calibration.

FIG. 2 is a diagram for describing a plurality of pattern images according to an exemplary embodiment of the present invention.

FIG. 3 is a diagram for describing a process of acquiring a plurality of primary features according to an exemplary embodiment of the present invention.

FIG. 4 is a diagram for describing a process of acquiring a plurality of secondary features according to an exemplary embodiment of the present invention.

FIG. 5 is a diagram for describing a refraction correction vector according to an exemplary embodiment of the present invention.

### DETAILED DESCRIPTION OF THE EMBODIMENTS

The present invention will be described more fully hereinafter with reference to the accompanying drawings, in which various exemplary embodiments of the invention are shown. The exemplary embodiments can be realized in various different forms, and is not limited to the exemplary embodiments described herein.

Parts not associated with description are omitted for clearly describing the exemplary embodiment of the present invention and like reference numerals designate like elements throughout the specification. Therefore, the reference numeral of the element used in the previous drawing may be used in the next drawing.

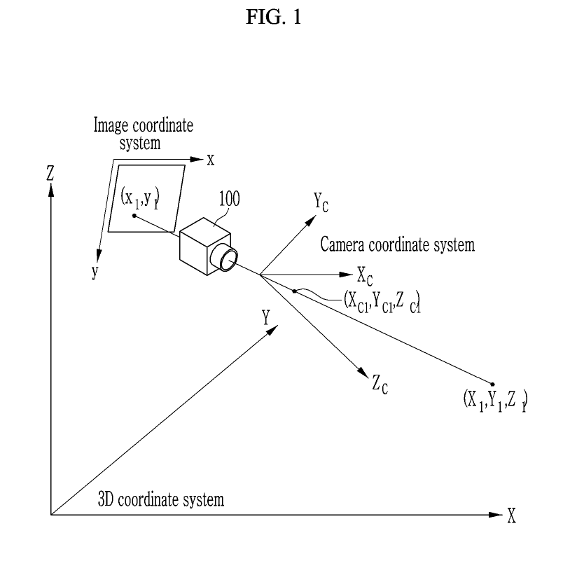

FIG. 1 is a diagram for describing camera calibration.

Referring to FIG. 1, a 3D coordinate system, a camera coordinate system, and an image coordinate system are illustrated.

The camera calibration aims at accurately mapping a 3D point (X₁, Y₁, Z₁) of the 3D coordinate system to a 2D point (x₁, y₁) of the image coordinate system. The 3D point (X₁, Y₁, Z₁) of the 3D coordinate system is mapped to a point (X_{C1}, Y_{C1}, Z_{C1}) of the camera coordinate system by reflecting the position and a rotational direction of the camera 100 and the point (X_{C1}, Y_{C1}, Z_{C1}) is mapped to the point (x₁, y₁) of the image coordinate system to which a lens configuration, an image sensor configuration, a distance and an angle between a lens and an image sensor, and the like of the camera 100 are reflected.

In general, parameterizing camera extrinsic factors such as the position and the rotational direction of the camera 100 is referred to as a camera extrinsic parameter and parameterizing camera intrinsic factors including the lens configuration, the image sensor configuration, the distance and the angle between the lens and the image sensor, and the like of the camera 100 is referred to as a camera intrinsic parameter. According to the following exemplary Equations 1 and 2, one point (X₁, Y₁, Z₁) of the 3D coordinate system is multiplied by the camera extrinsic parameter [R|t] and the camera intrinsic parameter A to acquire the point (x₁, y₁) of the image coordinate system.

$$\begin{matrix}λ [ \begin{matrix}{x}_{1} \\ {y}_{1} \\ 1\end{matrix} ] = A [ R \vert t ] [ \begin{matrix}{X}_{1} \\ {Y}_{1} \\ {Z}_{1} \\ 1\end{matrix} ] & [ Equation 1 ] \\ λ [ \begin{matrix}{x}_{1} \\ {y}_{1} \\ 1\end{matrix} ] = [ \begin{matrix}{f}_{x} & {skew}_{c} & {c}_{x} \\ 0 & {f}_{y} & {c}_{y} \\ 0 & 0 & 1\end{matrix} ] [ \begin{matrix}{r}_{11} & {r}_{21} & {r}_{31} & {t}_{1} \\ {r}_{21} & {r}_{22} & {r}_{23} & {t}_{2} \\ {r}_{31} & {r}_{32} & {r}_{33} & {t}_{3}\end{matrix} ] & [ Equation 2 ]\end{matrix}$$

The camera intrinsic parameter A may include fₓ and f_{y} which are focal lengths, cₓ and c_{y} which are principal points, and skew_c which is a skew coefficient. The camera extrinsic parameter [R|t] may include rotational vectors r11 to r33 and movable vectors t1, t2, and t3. λ represents a predetermined constant for expressing the image coordinate system by a homogeneous coordinate (that is, making a third item be 1).

When the camera calibration method is simplified, the camera calibration method means a method for accurately acquiring the camera extrinsic parameter and the camera intrinsic parameter to the maximum. Acquiring accurate solutions for the camera extrinsic parameter and the camera intrinsic parameter may depend on a detailed situation at the time of performing the calibration and since acquiring the accurate solutions requires unnecessarily many operations, acquiring the accurate solutions generally uses an estimation value acquired by using an optimization technique such as a Levenberg-Marquardt (LM) method.

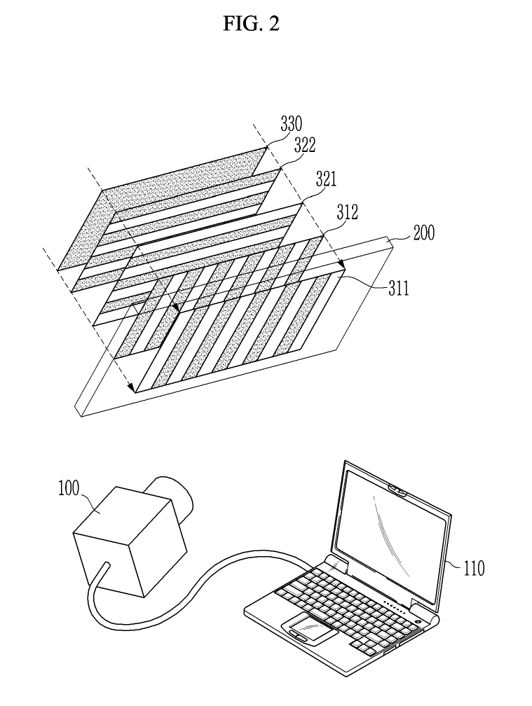

FIG. 2 is a diagram for describing a plurality of pattern images according to an exemplary embodiment of the present invention.

Referring to FIG. 2, the plurality of pattern images according to the exemplary embodiment includes a first vertical pattern image 311, a second vertical pattern image 312, a first horizontal pattern image 321, a second horizontal pattern image 322, and a monochromatic pattern image 330.

The second vertical pattern image 312 is complementary to the first vertical pattern image 311 and the second horizontal pattern image 322 is complementary to the first horizontal pattern image 321. In the exemplary embodiment, the first vertical pattern image 311 is a vertical stripe pattern in which first and second colors are alternated and the second vertical pattern image 312 is the vertical stripe pattern in which the second and first colors are alternated, which is complimentary to the first vertical pattern image 311. In the exemplary embodiment, the first horizontal pattern image 321 is a horizontal stripe pattern in which the first and second colors are alternated and the second horizontal pattern image 322 is the horizontal stripe pattern in which the second and first colors are alternated, which is complimentary to the first horizontal pattern image 321. In the exemplary embodiment, a case where the first color is a white color and the second color is a black color is described as an example.

In the exemplary embodiment, a case where the monochromatic pattern image 330 is the black color is described as an example.

A display apparatus 200 sequentially displays the plurality of pattern images 311, 312, 321, 322, and 3. The camera 100 photographs the plurality of pattern images 311, 312, 321, 322, and 330 to generate plural pattern image information corresponding to the plurality of pattern images 311, 312, 321, 322, and 330, respectively. The plural pattern image information includes first vertical pattern image information, second vertical pattern image information, first horizontal pattern image information, second horizontal pattern image information, and monochromatic pattern image information. The second vertical pattern image information is complimentary to the first vertical pattern image information and the second horizontal pattern image information is complimentary to the first horizontal pattern image information. The first vertical pattern image information is the vertical stripe pattern in which the first and second colors are alternated and the second vertical pattern image information may be the vertical stripe pattern in which the second and first colors are alternated, which is complimentary to the first vertical pattern image information. The first horizontal pattern image information is the horizontal stripe pattern in which the first and second colors are alternated and the second horizontal pattern image information may be the horizontal stripe pattern in which the second and first colors are alternated, which is complimentary to the first horizontal pattern image information.

A calibration apparatus 110 receives the plurality of pattern image information from the camera 100. The calibration apparatus 110 may be computing apparatuses including a desktop, a notebook, and the like. The calibration apparatus 110 may perform an operation of a calibration algorithm or program stored in a memory therein through a digital signal processor (DSP), and the like. In FIG. 2, it is illustrated that the calibration apparatus 110 is the notebook, but the calibration algorithm according to the exemplary embodiment may be stored in the camera 100. In this case, a separate calibration apparatus 110 is not required.

The calibration apparatus 110 may first remove the monochromatic pattern image information from the first vertical pattern image information, the second vertical pattern image information, the first horizontal pattern image information, and the second horizontal pattern image information. For example, a brightness value of a pixel corresponding to the monochromatic pattern image information may be subtracted from the brightness value of each pixel of the first vertical pattern image information. The second vertical pattern image information, the first horizontal pattern image information, and the second horizontal pattern image information may also be similarly processed. Through such a processing, an image component by a light source other than the display apparatus 200 may be removed.

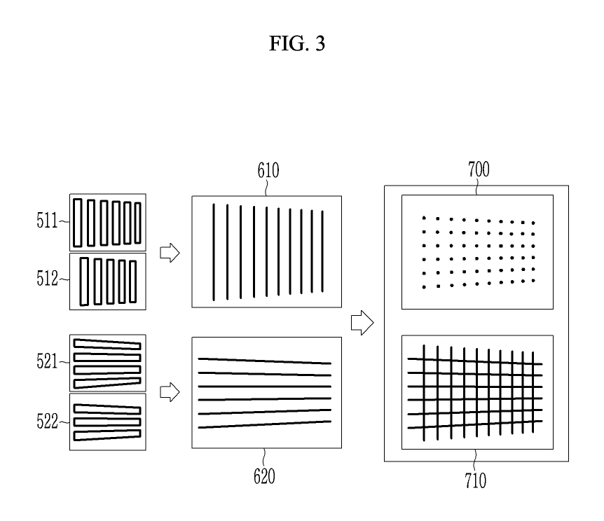

Next, the calibration apparatus 110 Gaussian-blurs the first vertical pattern image information, the second vertical pattern image information, the first horizontal pattern image information, and the second horizontal pattern image information to generate plural pattern correction image information including first vertical pattern correction image information 511, second vertical pattern correction image information 512, first horizontal pattern correction image information 521, and second horizontal pattern correction image information 522 (see FIG. 3). A Gaussian blur kernel used herein may have a predetermined standard deviation value. Through such a processing, an error by noise of an image is reduced and the calibration method according to the exemplary embodiment may be applied even to an image which accurately focuses on the pattern.

FIG. 3 is a diagram for describing a process of acquiring a plurality of primary features according to an exemplary embodiment of the present invention.

Referring to FIG. 3, illustrated is a process of generating plural skeleton information 610 and 620 by using the plural pattern correction image information 511, 512, 521, and 522 and acquiring a plurality of primary features 700 by using the plural skeleton information 610 and 620.

Vertical skeleton information 610 is generated by using points where edges of patterns of the first vertical pattern correction image information 511 and the second vertical pattern correction image information 512 overlap with each other.

$${E}_{v} = \{ \begin{matrix}1 - \frac{max ( {I}_{v} , {I}_{v}^{c} ) - min ( {I}_{v} , {I}_{v}^{c} )}{0.5 \sum {I}_{b}} , & if {I}_{b} > α , \\ 0 , & otherwise\end{matrix} \qquad [ Equation 3 ]$$

Eᵥ to be acquired in Equation 3 is vertical edginess information. Eᵥ is calculated for each pixel.

In Equation 3, Iᵥ represents the first vertical pattern correction image information 511, Iᵥ^{c} represents the second vertical pattern correction image information 512, and ΣI_{b} represents the sum of the plural pattern correction image information 511, 512, 521, and 522. α as a threshold value for excluding an area (an area other than the display apparatus) of which brightness is close to 0 has a predetermined value of 0.1 in the exemplary embodiment.

Eᵥ calculated through Equation 3 given above has the value which is close to 0 in an area other than the edge of the pattern and a value which is approximate to 1.0 as the value is closer to the edge of the pattern. When masking of setting pixels which are larger than 0.9 as a threshold value to true is performed with respect to the Eᵥ having the threshold value of 0.9 and a line of each edginess which is roughly extracted is processed to have a thickness of 1, the vertical skeleton information 610 may be extracted. Herein, the thickness is a pixel unit.

In the same manner, horizontal skeleton information 620 is generated by using the points where the edges of the patterns of the first horizontal pattern correction image information 521 and the second horizontal pattern correction image information 522 overlap with each other.

$${E}_{v} = \{ \begin{matrix}1 - \frac{max ( {I}_{v} , {I}_{v}^{c} ) - min ( {I}_{h} , {I}_{h}^{c} )}{0.5 \sum {I}_{b}} , & if {I}_{b} > α , \\ 0 , & otherwise\end{matrix} \qquad [ Equation 4 ]$$

Eₕ to be acquired in Equation 4 is horizontal edginess information. Eₕ is calculated for each pixel.

In Equation 4, Iₕ represents the first horizontal pattern correction image information 521, Iₕ^{c} represents the second horizontal pattern correction image information 522, and ΣI_{b} represents the sum of the plural pattern correction image information 511, 512, 521, and 522. α as the threshold value for excluding the area (the area other than the display apparatus) of which brightness is close to 0 has the predetermined value of 0.1 in the exemplary embodiment.

Eₕ calculated through Equation 4 given above has the value which is close to 0 in the area other than the edge of the pattern and the value which is approximate to 1.0 as the value is closer to the edge of the pattern. When masking of setting pixels which are larger than 0.9 as a threshold value to true is performed with respect to the Eₕ having the threshold value of 0.9 and the line of each edginess which is roughly extracted is processed to have the thickness of 1, the horizontal skeleton information 620 may be extracted. Herein, the thickness is the pixel unit.

An intersection is performed between the vertical skeleton information 610 and the horizontal skeleton information 620 to set the points which overlap with each other as the plurality of primary features 700 and acquire the positions of the points. Further, a lattice pattern 710 may be generated by performing a union of the vertical skeleton information 610 and the horizontal skeleton information 620 and an order relationship among the plurality of primary features 700 may be determined by searching the lattice pattern 710.

Referring back to Equations 1 and 2, each of the plurality of primary features 700 may correspond to the point (x1, y1) of the image coordinate system and each of correspondence points of the plurality of pattern images 311, 312, 321, 322, and 330 to the point (x1, y1) may correspond to the point (X1, Y1, Z1) of the 3D coordinate system. Therefore, the camera extrinsic parameter [R|t] and the camera intrinsic parameter A are estimated and acquired according to a plurality of operations for a plurality of coordinates.

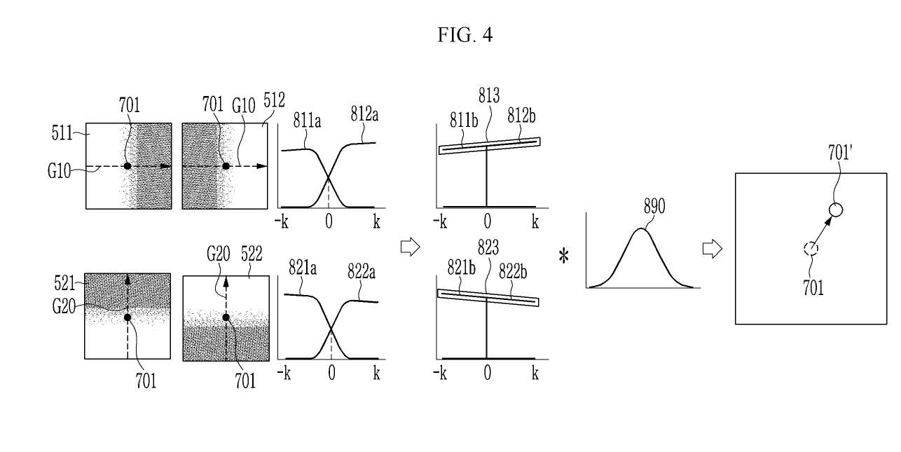

FIG. 4 is a diagram for describing a process of acquiring a plurality of secondary features according to an exemplary embodiment of the present invention.

According to the exemplary embodiment of FIG. 4, the plurality of secondary features of the coordinate may be acquired, which is more accurate than the plurality of primary features 700 and a defocus degree for the area for each of the plurality of secondary features may be estimated.

First, a plurality of first vertical pattern brightness profiles and a plurality of second vertical pattern brightness profiles in a plurality of vertical pattern gradient directions are acquired based on the plurality of primary features 700 in each of the first vertical pattern correction image information 511 and the second vertical pattern correction image information 512. Such a processing may be performed with respect to each of the primary features and hereinafter, such a processing will be described based on the primary feature 701. The same processing may be performed even with respect to other primary features.

A vertical pattern gradient direction G10 for the primary feature 701 may be commonly estimated from the first vertical pattern correction image information 511 and the second vertical pattern correction image information 512. The estimated vertical pattern gradient direction G10 is approximate to a symmetric axis direction of the pattern to acquire a first vertical pattern brightness profile 811a and a second vertical pattern brightness profile 812a in the vertical pattern gradient direction G10.

When Fᵥ which is the first vertical pattern brightness profile 811a is shown by an exemplary equation, Fᵥ is shown in Equation 5 given below and when Fᵥ^{c} which is the second vertical pattern brightness profile 812a is shown in the exemplary equation, Fᵥ^{c} is shown in Equation 6 given below.

Fᵥ[x|p,q]=Iᵥ(p+x cos φᵥ(p,q),q+x sin φᵥ(p,q)) [Equation 5]

Fᵥ_{^{c}}[x|p,q]=Iᵥ^{c}(p+x cos φᵥ(p,q),q+x sin φᵥ(p,q)) [Equation 6]

x represents an integer in the range of −k to k and when x is 0, the gradient direction G10 passes through a coordinate (p, q) of the primary feature 701. Iᵥ and Iᵥ^{c} mean the first vertical pattern correction image information 511 and the second vertical pattern correction image information 512, respectively. In the exemplary embodiment, φᵥ(p,q) is calculated by using a Scharr operator in the gradient direction G10 in the coordinate (p, q) of the primary feature 701 and averaging φᵥ(p,q) through a 3*3 window is used to be strong against noise.

Next, a plurality of vertical pattern single profiles is acquired by summing up the plurality of first vertical pattern brightness profiles and the plurality of second vertical pattern brightness profiles corresponding thereto. In addition, the plurality of vertical pattern single profiles is separated so that the brightness profiles minimally overlap with each other based on the plurality of primary features to acquire a plurality of first vertical pattern anticipated brightness profiles and a plurality of second vertical pattern anticipated brightness profiles.

The first vertical pattern correction image information 511 and the second vertical pattern correction image information 512 are complimentary to each other, and as a result, the first vertical pattern brightness profile 811a and the second vertical pattern brightness profile 812a are also complimentary to each other. Therefore, when the first vertical pattern brightness profile 811a and the second vertical pattern brightness profile 812a are summed up, a vertical pattern single profile 813 which is close to a straight line may be acquired. That is, the vertical pattern single profile 813 may be substantially the same as a brightness profile when a white image is photographed.

When the vertical pattern single profile 813 is separated so that the brightness profiles minimally overlap with each other based on the primary feature 701, a first vertical pattern anticipated brightness profile 811b and a second vertical pattern anticipated brightness profile 812b may be mathematically acquired. The first vertical pattern anticipated brightness profile 811b and the second vertical pattern anticipated brightness profile 812b may substantially have a sharp shape which is similar to a step function. The vertical pattern single profile 813 is first acquired and mathematically separated to acquire the first vertical pattern anticipated brightness profile 811b and the second vertical pattern anticipated brightness profile 812b, thereby reflecting non-uniform brightness of the display apparatus 200. When the step function is just acquired based on the primary feature 701 and used as the first vertical pattern anticipated brightness profile 811b and the second vertical pattern anticipated brightness profile 812b, the non-uniform brightness of the display apparatus 200 may not be reflected.

When Hᵥ which is the first vertical pattern anticipated brightness profile 811b is shown by the exemplary equation, Hᵥ is shown in Equation 7 given below and when Hᵥ^{c} which is the second vertical pattern anticipated brightness profile 812b is shown in the exemplary equation, Hᵥ^{c} is shown in Equation 8 given below.

$$\begin{matrix}{H}_{v} [ x \vert p , q ] = \{ \begin{matrix}{F}_{v} [ x \vert p , q ] + {F}_{{v}^{c}} [ x \vert p , q ] , & x < 0 \\ 0.5 ( {F}_{v} [ x \vert p , q ] + {F}_{{v}^{c}} [ x \vert p , q ] ) , & x = 0 \\ 0 , & x > 0\end{matrix} & [ Equation 7 ] \\ {H}_{{v}^{c}} [ x \vert p , q ] = \{ \begin{matrix}0 , & x < 0 \\ 0.5 ( {F}_{v} [ x \vert p , q ] + {F}_{{v}^{c}} [ x \vert p , q ] ) , & x = 0 \\ {F}_{v} [ x \vert p , q ] + {F}_{{v}^{c}} [ x \vert p , q ] , & x > 0\end{matrix} & [ Equation 8 ]\end{matrix}$$

At a separation point (x=0), each of Hᵥ and Hᵥ^{c} has an intermediate value.

In the same manner, a plurality of first horizontal pattern brightness profiles and a plurality of second horizontal pattern brightness profiles in a plurality of horizontal pattern gradient directions are acquired based on the plurality of primary features 700 in each of the first horizontal pattern correction image information 521 and the second horizontal pattern correction image information 522. Such a processing may be performed with respect to each of the primary features and hereinafter, such a processing will be described based on the primary feature 701. The same processing may be performed even with respect to other primary features.

The horizontal pattern gradient direction G20 for the primary feature 701 may be commonly estimated from the first horizontal pattern correction image information 521 and the second horizontal pattern correction image information 522. The estimated horizontal pattern gradient direction G20 is approximate to the symmetric axis direction of the pattern to acquire a first horizontal pattern brightness profile 821a and a second horizontal pattern brightness profile 822a in the horizontal pattern gradient direction G20.

When Fₕ which is the first horizontal pattern brightness profile 821a is shown by the exemplary equation, Fₕ is shown in Equation 9 given below and when Fₕ^{c} which is the second horizontal pattern brightness profile 822a is shown in the exemplary equation, Fₕ^{c} is shown in Equation 10 given below.

Fₕ[x|p,q]=Iₕ(p+x cos φₕ(p,q),q+x sin φₕ(p,q)) [Equation 9]

Fₕ_{^{c}}[x|p,q]=Iₕ^{c}(p+x cos φₕ(p,q),q+x sin φₕ(p,q)) [Equation 10]

x represents the integer in the range of −k to k and when x is 0, the gradient direction G20 passes through the coordinate (p, q) of the primary feature 701. Iₕ and Iₕ^{c} mean the first horizontal pattern correction image information 521 and the second horizontal pattern correction image information 522, respectively. In the exemplary embodiment, φₕ(p,q) is calculated by using the Scharr operator in the gradient direction G20 in the coordinate (p, q) of the primary feature 701 and averaging φₕ(p,q) through the 3*3 window is used to be strong against the noise.

Next, the plurality of horizontal pattern brightness profiles and the plurality of second horizontal pattern brightness profiles corresponding thereto are summed up, respectively to acquire the plurality of horizontal pattern single profiles. In addition, the plurality of horizontal pattern single profiles is separated so that the brightness profiles minimally overlap with each other based on the plurality of primary features to acquire a plurality of first horizontal pattern anticipated brightness profiles and a plurality of second horizontal pattern anticipated brightness profiles.

The first horizontal pattern correction image information 521 and the second horizontal pattern correction image information 522 are complimentary to each other, and as a result, the first horizontal pattern brightness profile 821a and the second horizontal pattern brightness profile 822a are also complimentary to each other. Therefore, when the first horizontal pattern brightness profile 821a and the second horizontal pattern brightness profile 822a are summed up, a horizontal pattern single profile 823 which is close to the straight line may be acquired. That is, the horizontal pattern single profile 823 may be substantially the same as the brightness profile when the white image is photographed.

When the horizontal pattern single profile 823 is separated so that the brightness profiles minimally overlap with each other based on the primary feature 701, the first horizontal pattern anticipated brightness profile 821b and the second horizontal pattern anticipated brightness profile 822b may be mathematically acquired. The first horizontal pattern anticipated brightness profile 821b and the second horizontal pattern anticipated brightness profile 822b may substantially have the sharp shape which is similar to the step function. The horizontal pattern single profile 823 is first acquired and mathematically separated to acquire the first horizontal pattern anticipated brightness profile 821b and the second horizontal pattern anticipated brightness profile 822b, thereby reflecting the non-uniform brightness of the display apparatus 200. When the step function is just acquired based on the primary feature 701 and used as the first horizontal pattern anticipated brightness profile 821b and the second horizontal pattern anticipated brightness profile 822b, the non-uniform brightness of the display apparatus 200 may not be reflected.

When Hₕ which is the first horizontal pattern anticipated brightness profile 821b is shown by the exemplary equation, Hₕ is shown in Equation 11 given below and when Hₕ^{c} which is the second horizontal pattern anticipated brightness profile 822b is shown in the exemplary equation, Hₕ^{c} is shown in Equation 12 given below.

$$\begin{matrix}{H}_{h} [ x \vert p , q ] = \{ \begin{matrix}{F}_{h} [ x \vert p , q ] + {F}_{{h}^{c}} [ x \vert p , q ] , & x < 0 \\ 0.5 ( {F}_{h} [ x \vert p , q ] + {F}_{{h}^{c}} [ x \vert p , q ] ) , & x = 0 \\ 0 , & x > 0\end{matrix} & [ Equation 11 ] \\ {H}_{{h}^{c}} [ x \vert p , q ] = \{ \begin{matrix}0 , & x < 0 \\ 0.5 ( {F}_{h} [ x \vert p , q ] + {F}_{{h}^{c}} [ x \vert p , q ] ) , & x = 0 \\ {F}_{h} [ x \vert p , q ] + {F}_{{h}^{c}} [ x \vert p , q ] , & x > 0\end{matrix} & [ Equation 12 ]\end{matrix}$$

At the separation point (x=0), each of Hₕ and Hₕ^{c} has the intermediate value.

Next, the plurality of secondary features is acquired, which allows values acquired by convoluting a plurality of anticipated Gaussian blur kernels with the plurality of first vertical pattern anticipated brightness profiles, the plurality of second vertical pattern anticipated brightness profiles, the plurality of first horizontal pattern anticipated brightness profiles, and the plurality of second horizontal pattern anticipated brightness profiles to have minimum differences from the plurality of first vertical pattern brightness profiles, the plurality of second vertical pattern brightness profiles, the plurality of first horizontal pattern brightness profiles, and the plurality of second horizontal pattern brightness profiles, with respect to the plurality of respective primary features. Herein, the anticipated Gaussian blur kernel may be expressed as a normalized Gaussian function as shown in Equation 13 given below.

$$G [ x \vert σ ] = \frac{1}{σ \sqrt{2 π}} {e}^{- {x}^{2} / 2 {σ}^{2}} \qquad [ Equation 13 ]$$

For example, a secondary feature 701′ may be acquired through Equation 14 given below with respect to the primary feature 701.

{p′,q′,σ′}=argmin_{p,q,σ}Σ_{bε{v,v}_{^{c}}_{,h,h}_{^{c}}_{}}∥F_{b}−H_{b}*G∥² [Equation 14]

A coordinate (p′, q′) is the coordinate of the secondary feature 701′ and σ′ represents a standard deviation of a finally estimated anticipated Gaussian blur kernel 890. A function argmin means the LM method and is repeatedly performed until final optimal {p′,q′, σ′} is estimated. It is noted that items F_{b}, H_{b}, and G in the equation are calculated again based on the aforementioned equation by using current estimation values p, q, and a for each iteration during an optimization process through the LM method.

Therefore, a processing using Equation 14 is performed independently from all of the plurality of primary features 700 to acquire the plurality of secondary features corresponding to the plurality of primary features 700, respectively. Further, since the standard deviation of the anticipated Gaussian blur kernel 890 may be acquired, which corresponds to each of the plurality of primary features 700, the defocus degree (the size of the Gaussian blur) for each point may be known.

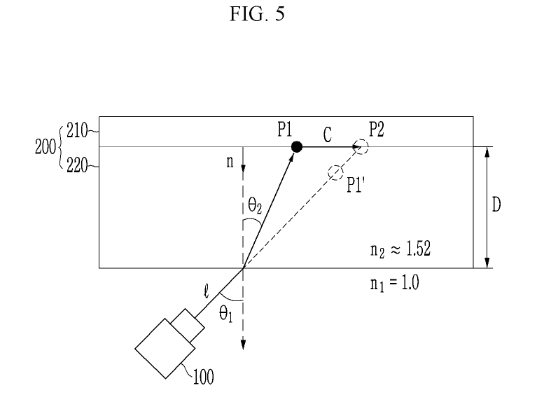

FIG. 5 is a diagram for describing a refraction correction vector according to an exemplary embodiment of the present invention.

Referring to FIG. 5, a display apparatus 200 includes a display panel 210 and a front panel 220. The display panel 210 may include display panels having various structures, which include a liquid crystal display (LCD) panel, an organic light emitting diode (OLED) panel, and the like. The display panel 210 generally includes a plurality of pixels and displays a displayed image by combining emission degrees of the plurality of pixels. The front panel 220 may be a transparent panel attached in order to protect the display panel 210. The front panel 220 may be made of a transparent material such as glass or plastic.

Due to a refraction phenomenon of light, which occurs in the front panel 220, when the position of an actual feature is P1, the camera 100 recognizes P1 in a direction to view P1′. Such an error occurs more significantly particularly in the case of a calibration within a short range. Therefore, in the exemplary embodiment, a refraction correction vector c to which a refractive index n2 of the front panel 220 is reflected may be calculated in order to correct such an error. When the calculated refraction correction vector c is reflected, the coordinate of the recognized feature may be corrected from P1 to P2.

The refraction correction vector c may be calculated as shown in Equation 15 given below.

$$c = D ( \frac{1}{\vert n \cdot l \vert} - \frac{1}{\sqrt{{n}_{2}^{2} - 1 + {( n \cdot l )}^{2}}} ) [ l - ( n \cdot l ) n ] \qquad [ Equation 15 ]$$

In this case, the refractive index n₂ of the front panel 220 is a fixed value and as the refractive index n₂ of the front panel 220, a value between 1.52 which is the refractive index of crown glass and 1.62 which is the refractive index of flint glass may be used. The reason for using the fixed value as the refractive index n₂ is to prevent a problem of overfitting. The material of the front panel is not limited to glass. If a user knows the refractive index of the front panel, it is best to use the exact value.

I represents a vector toward the coordinate P1′ in the camera 100 and n represents a normal vector of the display panel 210 based on a camera coordinate system. D as the thickness of the front panel 220 represents a value to be estimated below.

According to the exemplary embodiment, the parameter of the camera to which the refraction correction vector c is reflected may be acquired by exemplary Equation 16 given below.

{K′,k′,p′,R′,t′,D′}=argmin_{K,k,p,R,t,D}ΣᵢΣⱼ∥ũᵢⱼ− [symbol] K[π(k,p,RᵢXⱼ+tᵢ+cᵢⱼ)] [symbol] ∥² [Equation 16]

ũᵢⱼ means the coordinate of a j-th feature extracted at an i-th angle. During the calibration, the camera 100 may photograph the display apparatus 200 at various angles and positions. ũᵢⱼ may mean the secondary feature point or the primary feature.

K, k, and p represent the camera intrinsic parameters and in detail, K represents a camera intrinsic matrix including a focal distance, an asymmetric coefficient, and a principal point, k represents a lens radial distortion parameter, and p represents a lens tangential distortion parameter. R and t represent the camera extrinsic parameters and in detail, R represents a rotation matrix and t represents a translation vector. Xⱼ represents a 3D coordinate of the j-th feature. π represents a lens distortion function. A function <•> as a vector normalization function is calculated as shown in

$$〈 ( x , y , z ) 〉 = ( \frac{x}{z} , \frac{y}{z} ) .$$

Referring to Equation 16, it can be seen that Xⱼ which is the 3D coordinate is converted into the camera coordinate system and thereafter, a refraction correction vector cᵢⱼ according to the exemplary embodiment is added to the camera coordinate system. In addition, the lens distortion function and the camera intrinsic matrix are sequentially applied and converted into a 2D value and thereafter, a result value is compared with ũᵢⱼ. As a comparison result, {K′, k′, p′, R′, t′, D′} in which the sum of the differences is smallest may be estimated as an optimal solution. Herein, the LM method may be used.

In a calibration method using multi-cameras, relative rotation and translation vectors between the cameras may be added as the parameters and the refraction correction vector may be reflected at the time of calculating a reprojection error, in applying Equation 16.

The drawings referred and the detailed description of the present invention disclosed up to now are just used for exemplifying the present invention and they are just used for the purpose of describing the present invention, but not used for limiting a meaning or restricting the scope of the present invention disclosed in the claims. Therefore, it will be appreciated by those skilled in the art that various modifications and other exemplary embodiments equivalent thereto can be made therefrom. Accordingly, the true technical scope of the present invention should be defined by the technical spirit of the appended claims.

### DESCRIPTION OF SYMBOLS

100: Camera
110: Calibration apparatus
200: Display apparatus
210: Display panel
220: Front panel
311: First vertical pattern image
312: Second vertical pattern image
321: First horizontal pattern image
322: Second horizontal pattern image
330: Monochromatic pattern image

What is claimed is:

1. A camera calibration method of a calibration apparatus, comprising:
receiving plural pattern image information photographed by a camera;
setting points where edges of patterns of the plural pattern image information overlap with each other as a plurality of primary features; and
calibrating the camera by using the plurality of primary features,
wherein the plural pattern image information includes first vertical pattern image information, second vertical pattern image information complimentary to the first vertical pattern image information, first horizontal pattern image information, and second horizontal pattern image information complementary to the first horizontal pattern image information.

2. The camera calibration method of claim 1, wherein:
the plural pattern image information further includes monochromatic pattern image information,
the method further comprising removing monochromatic pattern image information from the first vertical pattern image information, the second vertical pattern image information, the first horizontal pattern image information, and the second horizontal pattern image information.

3. The camera calibration method of claim 2, further comprising:
generating plural pattern correction image information including first vertical pattern correction image information, second vertical pattern correction image information, first horizontal pattern correction image information, and second horizontal pattern correction image information by Gaussian-blurring the first vertical pattern image information, the second vertical pattern image information, the first horizontal pattern image information, and the second horizontal pattern image information.

4. The camera calibration method of claim 3, wherein:
the setting of the points as the plurality of primary features includes,
generating vertical skeleton information by using the points where the edges of the patterns of the first vertical pattern correction image information and the second vertical pattern correction image information overlap with each other,
generating horizontal skeleton information by using the points where the edges of the patterns of the first horizontal pattern correction image information and the second horizontal pattern correction image information overlap with each other, and
setting points where the vertical skeleton information and the horizontal skeleton information overlap with each other as the plurality of primary features.

5. The camera calibration method of claim 4, wherein:
the calibrating of the camera by using the plurality of primary features includes,
acquiring a plurality of first vertical pattern brightness profiles and a plurality of second vertical pattern brightness profiles in a plurality of vertical pattern gradient directions based on the plurality of primary features in each of the first vertical pattern correction image information and the second vertical pattern correction image information,
acquiring a plurality of first horizontal pattern brightness profiles and a plurality of second horizontal pattern brightness profiles in a plurality of horizontal pattern gradient directions based on the plurality of primary features in each of the first horizontal pattern correction image information and the second horizontal pattern correction image information,
acquiring a plurality of secondary features corresponding to the plurality of primary features by using the plurality of first vertical pattern brightness profiles, the plurality of second vertical pattern brightness profiles, the plurality of first horizontal pattern brightness profiles, and the plurality of second horizontal pattern brightness profiles, and
calibrating the camera by using the plurality of secondary features.

6. The camera calibration method of claim 5, wherein:
the acquiring of the plurality of secondary features corresponding to the plurality of primary features includes,
acquiring a standard deviation of a plurality of anticipated Gaussian blur kernels corresponding to the plurality of secondary features.

7. The camera calibration method of claim 5, wherein:
the acquiring of the plurality of secondary features corresponding to the plurality of primary features includes,
acquiring a plurality of vertical pattern single profiles by summing up the plurality of first vertical pattern brightness profiles and the plurality of second vertical pattern brightness profiles corresponding thereto,
acquiring a plurality of first vertical pattern anticipated brightness profiles and a plurality of second vertical pattern anticipated brightness profiles by separating the plurality of vertical pattern single profiles so that the brightness profiles minimally overlap with each other based on the plurality of primary features,
acquiring a plurality of horizontal pattern single profiles by summing up the plurality of first horizontal pattern brightness profiles and the plurality of second horizontal pattern brightness profiles corresponding thereto,
acquiring a plurality of first horizontal pattern anticipated brightness profiles and a plurality of second horizontal pattern anticipated brightness profiles by separating the plurality of horizontal pattern single profiles so that the brightness profiles minimally overlap with each other based on the plurality of primary features, and
acquiring the plurality of secondary features which allows values acquired by convoluting a plurality of anticipated Gaussian blur kernels with the plurality of first vertical pattern anticipated brightness profiles, the plurality of second vertical pattern anticipated brightness profiles, the plurality of first horizontal pattern anticipated brightness profiles, and the plurality of second horizontal pattern anticipated brightness profiles to have minimum differences from the plurality of first vertical pattern brightness profiles, the plurality of second vertical pattern brightness profiles, the plurality of first horizontal pattern brightness profiles, and the plurality of second horizontal pattern brightness profiles, with respect to the plurality of respective primary features.

8. The camera calibration method of claim 5, wherein:
the calibrating of the camera by using the plurality of secondary features includes,
calculating a refraction correction vector to which a refractive index of a front panel of a display apparatus is reflected, and
acquiring parameters of the camera by using the refraction correction vector and the plurality of secondary features.

9. The camera calibration method of claim 8, wherein:
the acquiring of the parameters of the camera further includes
acquiring the thickness of the front panel.

10. The camera calibration method of claim 1, wherein:
the first vertical pattern image information is the vertical stripe pattern in which the first and second colors are alternated and the second vertical pattern image information is the vertical stripe pattern in which the second and first colors are alternated, which is complimentary to the first vertical pattern image information, and
the first horizontal pattern image information is the horizontal stripe pattern in which the first and second colors are alternated and the second horizontal pattern image information is the horizontal stripe pattern in which the second and first colors are alternated, which is complimentary to the first horizontal pattern image information.
